(19) United States
(12) Patent Application Publication
(10) Pub. No.: US 2015/0365133 A1
(43) Pub. Date: Dec. 17, 2015

(54) Touch and Talk Auto-Configuring of Video Conferences Using Near Field Communication (NFC)

(71) Applicant: Google Inc., Mountain View, CA (US)

(72) Inventors: Alan Viverette, Mountain View, CA (US); T.V Raman, Mountain View, CA (US); Naomi Black-Bilodeau, Mountain View, CA (US); Charles Chen, Mountain View, CA (US)

(21) Appl. No.: 13/841,493

(22) Filed: Mar. 15, 2013

(51) Int. Cl. H04B 5/00; H04N 7/15

(52) U.S. Cl. CPC H04B 5/0025; H04N 7/15

(57) ABSTRACT

An NFC reader in a communication device reads a first NFC tag on a first conference device when the communication device is brought within proximity of the first NFC tag. The communication device communicates information read from the first NFC tag and information acquired by the communication device to a conference server. The conference server utilizes the communicated information read from the first NFC tag and the communicated information acquired by the communication device to configure a conference call between the first conference device and the second conference device. The communication device, the first conference device and the second conference device are separate and distinct. The communication device executes a module that handles the communication of the information read from the first NFC tag and the information acquired by the communication device. The module is executed when the communication device is brought within the proximity of the first NFC tag.

### CROSS-REFERENCE TO RELATED APPLICATIONS/INCORPORATION BY REFERENCE

Not Applicable.

### FIELD

Certain embodiments of the disclosure relate to communication. More specifically, certain embodiments of the disclosure relate to a method and system for touch and talk auto-configuring of video conferences using near field communication (NFC).

### BACKGROUND

Many daily interactions with electronic equipment, for example, communication devices, video-conferencing units, electronic kiosks and the like require many repetitive user interaction steps for achieving common actions. Typical, user interaction steps include specifying what action to perform by a process of hierarchical selection, specifying additional parameters to the action, and specifying identifying information, and identity of the user requesting the action.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method is provided for touch and talk auto-configuring of video conferences using near field communication (NFC), substantially as shown in and/or described in connection with at least one of the figures, as set forth more completely in the claims.

A communication device includes an NFC reader, which is operable to read a first NFC tag on a first conference device when the communication device with the NFC reader is brought within proximity of the first NFC tag on the first conference device. The communication device is operable to communicate information read from the first NFC tag and information acquired by the communication device to a conference server. The conference server utilizes the communicated information read from the first NFC tag and the communicated information acquired by the communication device to configure a conference call between the first conference device and at least a second conference device. The communication device, the first conference device and at least the second conference device are separate and distinct devices.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an example NFC conference system, which may be utilized for touch and talk auto-configuring of a video conference, in accordance with an embodiment of the disclosure.

FIG. 2 is a block diagram of an example NFC enabled communication device and an NFC enabled conference device, which may be utilized for touch and talk auto-configuring of a video conference, in accordance with an embodiment of the disclosure.

FIG. 3 is a block diagram illustrating an example conference device, which may be utilized for touch and talk auto-configuring of a video conference, in accordance with an embodiment of the disclosure.

FIG. 4 is a flowchart illustrating example steps that may be utilized for providing touch and talk auto-configuring of a video conference using NFC, in accordance with an embodiment of the disclosure.

FIG. 5 is a flowchart illustrating example steps that may be utilized for providing touch and talk auto-configuring of a video conference using NFC, in accordance with an embodiment of the disclosure.

FIG. 6 is a diagram that illustrates an example system for providing touch and talk auto-configuring of a video conference using NFC, in accordance with an embodiment of the disclosure.

### DETAILED DESCRIPTION

Certain embodiments of the disclosure may be found in a method and system for touch and talk auto-configuring of video conferences using near field communication (NFC). A communication device comprising an NFC reader is operable to read a first NFC tag on a first conference device when the communication device comprising the NFC reader is brought within operating proximity of the first NFC tag on the first conference device. Information read from the first NFC tag and information acquired by the communication device may be communicated to a conference server. The conference server utilizes the communicated information read from the first NFC tag and the communicated information acquired by the communication device to configure a conference call between the first conference device and at least a second conference device. The conference call may comprise a voice conferencing call and/or video conferencing call. The communication device, the first conference device and at least the second conference device are separate and distinct devices. The communication device may execute a module that handles the communication of the information read from the first NFC tag and the information acquired by the communication device to the conference server.

The module on the communication device may be executed when the communication device is brought within the operating proximity of the first NFC tag on the first conference device. The module may comprise an application that runs on an operating system platform of the communication device or the module may be integrated as part of an operating system platform of the communication device. The information read from the first NFC tag may comprise data that uniquely identifies the first conference device. The communication device may utilize the information read from the first NFC tag to communicate with the conference server. The information acquired by the communication device and communicated to the conference server may comprise information that authenticates a user of the communication device that is a participant of the conference call. The information acquired by the communication device and communicated to the conference server may comprise information acquired from one or more of a calendar, an email, a note, and a social destination. The information acquired by the communication device and communicated to the conference server may comprise local information on the communication device and/or remote information from another entity or device. The communication device may be operable to initiate transfer of the conference call and/or resumption of the conference call from the first conference device to a third conference device comprising a third NFC tag when the communication device comprising the NFC reader is brought within proximity of the third NFC tag on the third conference device.

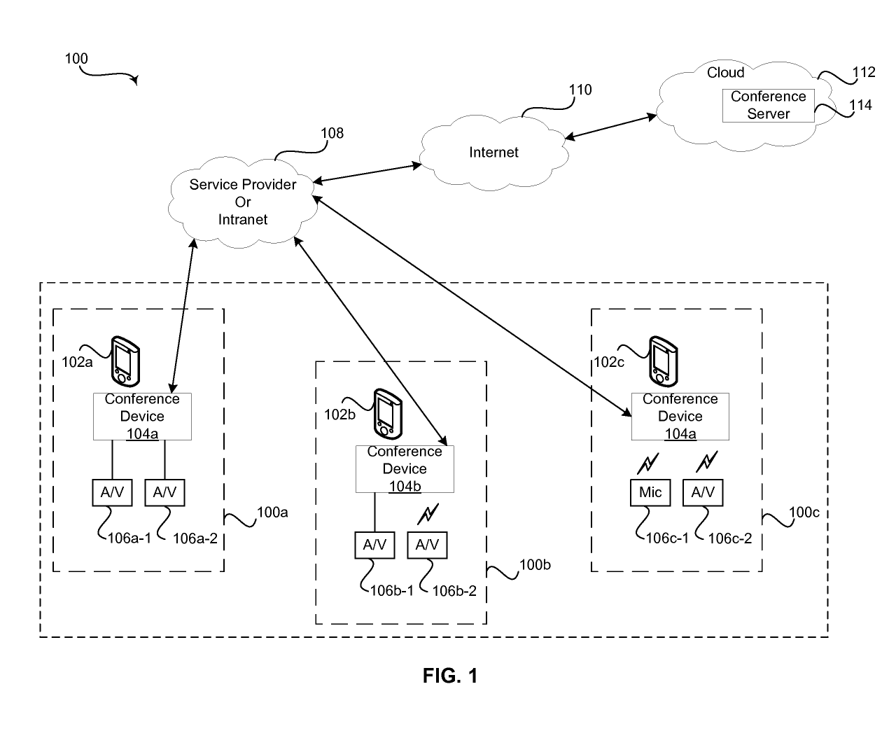

FIG. 1 is a block diagram of an example NFC conference system, which may be utilized for touch and talk auto-configuring of a video conference, in accordance with an embodiment of the disclosure. Referring to FIG. 1, there is shown a plurality of communication devices 102a, 102b, 102c, a plurality of conference devices 104a, 104b and 104c, a service provider or intranet 108, the Internet 110, a cloud 112 and a conference server 114. FIG. 1 also shows a plurality of audio/video devices 106a-1, 106a-2, 106b-1, 106b-2, 106c-1 and 106c-2. The communication device 102a, the conference device 104a, the audio/video devices 106a-1, 106a-2 may be located at a first location, namely 100a. The communication device 102b, the conference device 104b, the audio/video devices 106b-1, 106b-2 may be located at a second location, namely 100b. The communication device 102c, the conference device 104c, the audio/video devices 106c-1, 106c-2 may be located at a third location, namely 100c.

Each of the plurality of communication devices 102a, 102b, 102c may comprise suitable logic, circuitry, interfaces and/or code that may be operable to communicate with the conference devices 104a, 104b and 104c, respectively, and the conference server 114 via the service provider or intranet 108, the Internet 110, and the cloud 112. In accordance with an embodiment of the disclosure, each of the conference devices 104a, 104b and 104c may comprise an NFC reader that may be operable to read an NFC tag, which may be located in each of the conference devices 104a, 104b, 104c, respectively. The corresponding information read from the conference device may be utilized to setup and/or configure a conference call between the two or more of the conference devices 104a, 104b and 104c. For example, the communication device 102a may be operable to read an NFC tag in the conference device 104a and utilize the corresponding read information to setup and/or configure a conference call with the conference server 114. Similarly, the communication device 102b may be operable to read an NFC tag in the conference device 104b and utilize the corresponding read information to setup and/or configure a conference call with the conference server 114. Additionally, the communication device 102c may be operable to read an NFC tag in the conference device 104c and utilize the corresponding read information to setup and/or configure a conference call with the conference server 114.

Each of the plurality of conference devices 104a, 104b, 104c may comprise suitable logic, circuitry, interfaces and/or code that may be operable to communicate with the communication device 102a, 102b and 102c via NFC in order to setup and/or configure a conference call with the conference server 114. Each of the plurality of conference devices 104a, 104b, 104c may comprise and NFC tag which may be read by the communication device 102a, 102b and 102c, respectively. The information that may be read from each of the plurality of conference devices 104a, 104b, 104c may comprise a unique identifier and an identifier of conference server 114, which may be utilized to setup and/or configure the conference call.

Each of the plurality of audio/video devices 106a-1, 106a-2, 106b-1, 106b-2, 106c-1 and 106c-2 may comprise suitable logic, circuitry, interfaces and/or code that may be operable to capture audio and/or video content for a conference call. In this regard, each of the plurality of audio/video devices 106a-1, 106a-2, 106b-1, 106b-2, 106c-1 and 106c-2 may comprise a microphone and/or a camera that may be operable to capture the audio and/or video content, respectively, for the conference call.

The service provider or intranet 108 may comprise suitable devices, circuitry and/or interfaces that may be operable to provide connectivity between the communication devices 102a, 102b and 102c and/or the conference device 104a and the conference server 114 via the Internet 110. In this regard, once the communication devices 102a, 102b and 102c sets up and/or configures the conference devices 104a, 104b and 104c, respectively, for the conference call, the corresponding data, audio and/or video content for the conference call may be communicated amongst the conference devices 104a, 104b and 104c and the conference server 114 via the service provider and/or intranet 108. The communication devices 102a, 102b and 102c and/or the conference devices 104a, 104b and 104c may be operable to utilize WWAN, WLAN, WPAN technologies, for example, 3G, 4G, Bluetooth, WiFi including all variants thereof (802.11 a/b/g/n/e etc.) to communicate with the service provider or intranet 108.

The Internet 110 may comprise suitable devices, circuitry and/or interfaces in a network that is operable to host various Internet-based services and/or route Internet related traffic. The Internet related traffic may comprise multimedia information such as text, voice, video and/or data. The Internet 110 may be operable to route the corresponding setup data, data, audio and/or video content for the conference call amongst the conference devices 104a, 104b and 104c and the conference server 114.

The cloud 112 may comprise suitable devices, circuitry and/or interfaces in a network that is operable to host one or more services such as the conferencing service that may be provided by the conference server 114.

The conference server 114 may comprise suitable logic, circuitry, interfaces and/or code that may be operable to receive conference call setup and/or configuration information from the communication devices 102a, 102b and 102c. The conference server 114 may be a cloud based device that may be located in the cloud 112. The conference server 114 may utilize the received conference call setup and/or configuration information to setup and/or configure the conference call amongst the conference devices 104a, 104b and 104c. The configuration information that may be received from the communication devices 102a, 102b and 102c may comprise a unique identifier that identifies the conference devices 104a, 104b and 104c and/or the capabilities of each of the conference devices 104a, 104b and 104c, respectively.

In operation, the communication device 102a may be placed within operating proximity of the conference device 104a in order to setup a conference call through the conference server 114. Since near field communication is a wireless communication technology that enables short range communication of data over a range of approximately 4 cm, the communication device 102a may be placed within this range of the conference device 104a.

The NFC reader in the communication device 102a may read information from the conference device 104a that identifies, for example, a location and/or identifier of the conference server 114 and a unique identifier of the conference device 104a. In an example embodiment of the disclosure, a location and/or identifier of the conference server 114 may comprise a uniform resource locator (URL). Once the communication device 102a determines the location and/or identifier of the conference server 114, the communication device 102a may be operable to send the unique identifier of the conference device 104a and/or information identifying the capabilities of the conference device 104a to the conference server 114. The conference server 114 may be operable to utilize the unique identifier of the conference device 104a and/or the information identifying the capabilities of the conference device 104a to establish the conference call.

The communication device 102b may be placed within operating proximity of the conference device 104b in order to add the communication device 104b to the conference call. The NFC reader in the communication device 102b may read information from the conference device 104b that identifies, for example, a location, address and/or identifier of the conference server 114 and a unique identifier of the conference device 104b. In an example embodiment of the disclosure, a location, address and/or identifier of the conference server 114 may comprise a uniform resource locator (URL). Once the communication device 102b determines the location and/or identifier of the conference server 114, the communication device 102b may be operable to send the unique identifier of the conference device 104b and/or information identifying the capabilities of the conference device 104b to the conference server 114. The conference server 114 may be operable to utilize the unique identifier of the conference device 104b and/or the information identifying the capabilities of the conference device 104b to add the conference device 104b to the conference call. The conference device 104a and the conference device 104b are now part of the conference call.

The communication device 102c may be placed within operating proximity of the conference device 104c in order to add the communication device 104c to the conference call. The NFC reader in the communication device 102c may read information from the conference device 104c that identifies, for example, a location and/or identifier of the conference server 114 and a unique identifier of the conference device 104c. In an example embodiment of the disclosure, a location and/or identifier of the conference server 114 may comprise a uniform resource locator (URL). Once the communication device 102c determines the location and/or identifier of the conference server 114, the communication device 102c may be operable to send the unique identifier of the conference device 104c and/or information identifying the capabilities of the conference device 104c to the conference server 114. The conference server 114 may be operable to utilize the unique identifier of the conference device 104c and/or the information identifying the capabilities of the conference device 104c to add the conference device 104c to the conference call. The conference device 104a, the conference device 104b and the conference device 104c are now part of the conference call.

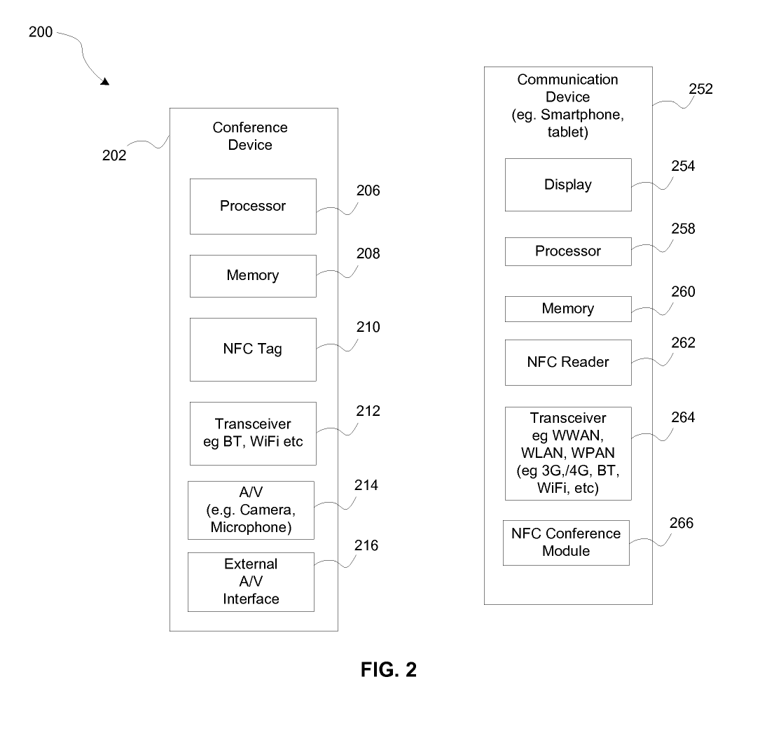

FIG. 2 is a block diagram of an example NFC enabled communication device and an NFC enabled conference device, which may be utilized for touch and talk auto-configuring of a video conference, in accordance with an embodiment of the disclosure. Referring to FIG. 2, there is shown a system 200, which comprises a conference device 202 and a communication device 252. The conference device 202 comprises a processor 206, a memory 208, a NFC tag 210, a transceiver 212, an audio/video device 214 and an external audio/video device interface 216. The communication device 252 may comprise a display 254, a processor 258, a memory 260, a NFC reader 262, transceiver 264 and a NFC conference module.

The conference device 202 may comprise suitable logic, circuitry, interfaces and/or code that may be operable to provide video and/or audio conferencing capabilities. The conference device 202 may be substantially similar to the conference devices 104a, 104b and 104c.

The processor 206 may comprise suitable logic, circuitry, interfaces and/or code that may be operable to control one or more operations or functions of the conference device 202. In this regard, the processor 206 may be operable to receive and process signals for the NFC tag 210, the transceiver 212, the audio/video device 214 and/or the external audio/video interface 216.

The memory 208 may comprise suitable logic, circuitry, interfaces and/or code that may be operable to store one or more settings, configuration, and/or operating code and/or data for the conference device 202. For example, the memory 208 may be operable to store one or more settings, configuration, and/or operating code and/or data for the NFC tag 210, the transceiver 212, the audio/video device 214 and/or the external audio/video interface 216. In this regard, the memory 208 may be operable to store a corresponding NFC tag identifier (ID) for the NFC tag 210. The NFC tag ID may comprise an address of the conference device 202. Information read from the NFC tag in the conference device 202 may also comprise settings and/or capabilities of the conference device 202 and an address of a conference server 114 that handles the setup and configuration of conference calls for the conference device 202.

The NFC tag 210 may comprise suitable logic, circuitry, interfaces and/or code that may be operable to communicate utilizing NFC technology. The NFC tag 210 in the conference device 202 maybe operable to store information that identifies the conference device 202, information that identifies capabilities of the conference device 202 and/or an address or location of the conference server 114 (FIG. 1). A NFC reader such as the NFC reader 262 in the communication device 252 may be utilized to energize a coil within the NFC tag 210 to make the NFC tag 210 active.

The transceiver 212 may comprise suitable logic, circuitry, interfaces and/or code that may enable the conference device 202 to communicate with the conference server 114 (FIG. 1) via the service provider and/or the intranet 108, the Internet 110 and the cloud 112. In accordance with various embodiments of the disclosure, the transceiver 212 may be operable to utilize one or more wireless communication technologies such as WWAN, WLAN, WPAN, for example, 3G, 4G, Bluetooth, WiFi including all variants thereof (802.11 a/b/g/n/e etc).

The audio/video device 214 may comprise suitable logic, circuitry, interfaces and/or code that may be operable to capture audio and/or video content for a conference call. In this regard, the audio/video device 214 may comprise a microphone and/or a camera that may be operable to capture audio and video for the conference call. The audio/video device 214 may be substantially similar to the audio/video devices 106a-1, 106a-2, 106b-1, 106b-2, 106c-1 and 106c-2.

The external audio/video device interface 216 may comprise suitable logic, circuitry, interfaces and/or code that may enable one or more external audio or video devices to be coupled to the conference device 202. For example, the external audio/video device interface 216 may enable one or more external microphones and/or cameras to be communicatively coupled to the conference device 202. The one or more external microphones and/or cameras that may be communicatively coupled to the conference device 202 may be utilized to extend an audio and/or video range or coverage of the conference device 202. For example, if the conference device 202 is located in a large room with many conference participants, a plurality of external audio/video devices comprising microphones and/or cameras may be communicatively coupled to the conference device 202 via the external audio/video device interface 216 so that all the participants may be heard and/or viewed.

The communication device 252 may comprise suitable logic, circuitry, interfaces and/or code that may be operable to communicate with the conference device 202. The communication device 252 may comprise a smartphone, a tablet, and/or other similar type of device. The communication device 252 may be utilized to setup and/or configure a conference call utilizing the conference device 202. In this regard, the conference device 252 may be operable to utilize the NFC reader 262 to read the NFC tag 210 in order to acquire information from the conference device 202, which may be utilized to setup the conference call with the conference server 114. The communication device 252 may also be operable to execute the NFC conference module 266, which may be operable to control the setup and/or configuration of the conference call.

The display 254 may comprise suitable logic, circuitry, interfaces and/or code that may be operable to display control information and/or multimedia information such as content. The display 254 may be a LCD or a LED display, or variants thereof. The display 254 may comprise a touchscreen interface that may enable a user of the communication device 252 to setup and/or configure the conference call.

The processor 258 may comprise suitable logic, circuitry, interfaces and/or code that may be operable to control one or more operations or functions of the communication device 252. In this regard, the processor 258 may be operable to receive and process signals from and/or for the display 254, the NFC reader 262, the transceiver 264 and/or the NFC conference module 266. In accordance with an embodiment of the disclosure, the processor 258 may be operable to initiate the NFC conference module 266 whenever the communication device 252 is brought within operating proximity of the conference device 202.

The memory 260 may comprise suitable logic, circuitry, interfaces and/or code that may be operable to store one or more settings, configuration, and/or operating code and/or data for the conference device 202. In this regard, the memory 260 may be operable to store settings, configuration, and/or operating code and/or data for the transceiver 264, the NFC conference module 266, the processor 258 and/or the display 254.

The NFC reader 262 may comprise suitable logic, circuitry, interfaces and/or code that may be operable to communicate utilizing NFC technology. In this regard, whenever the NFC reader 262 is brought within operating proximity of the NFC tag 210, the NFC reader 262 in the communication device 252 may energize a coil within the NFC tag 210. In one embodiment of the disclosure, the NFC reader may read information from the NFC tag 210, which may be utilized to setup a conference call for the conference device 202.

The transceiver 264 may comprise suitable logic, circuitry, interfaces and/or code that may be operable to enable the communication device 252 to communicate with one or more other devices such as the conference device 202. In accordance with various embodiments of the disclosure, the transceiver 264 may be operable to utilize one or more wireless communication technologies such as Personal Area Networks (PANs) such as Bluetooth or ZigBee, and WiFi including all variants thereof (802.11 a/b/g/n/e etc.).

The NFC conference module 266 may comprise suitable logic, circuitry, interfaces and/or code that may be operable to read information from the NFC tag 210 in the conference device 202, which may be utilized to setup and/or configure the conference call. In accordance with an embodiment of the disclosure, the NFC conference module 266 may be executed whenever the communication device 252 is brought within operating proximity of the conference device 202. The NFC conference module 266 may enable the communication device 252 to acquire information from the NFC tag and information from the communication device, which may be utilized to setup and/or configure the conference call. For example, the NFC conference module 266 may enable the communication device 252 to determine an identity of the conference device and also a location of the conference server 114 (FIG. 1), which may be utilized to setup the conference call. The NFC conference module 266 may enable the communication device to communicate with the conference server 114 based on the determined location of the conference server 114. The NFC conference module 266 may also enable the conference device 252 to authenticate a user of the communication device.

The NFC conference module 266 may also be operable to interface with, for example, calendar, contacts, email, notes, one or more messages and/or one or more social destinations in order to acquire information that may be utilized to setup and/or configure a conference call. The NFC conference module 266 may also be operable to interface with the calendar, contacts, email, notes, one or more messages and/or one or more social destinations in order to authenticate a user, conference device and/or a communication device for a conference call.

The authentication may be utilized to ensure that the user of the communication device 252 and/or the communication device 252 is authorized to participate in the conference call. In various example embodiments of the disclosure, information from the calendar, contacts, email, a note, one or more messages, social destination and/or other similar type of source may be utilized to authenticate the user of the communication device 252 and/or the communication device 252.

In operation, the NFC reader 262 in the communication device 252 may be brought within operating proximity of the NFC tag 210 within the conference device 202. The NFC reader 262 is operable to read information from the NFC tag 210, which may be utilized by the communication device 252 to setup the conference call. For example, the NFC reader 210 may read information that identifies the conference device 202 and identifies the location of a conference server 114 that is enabled to setup and manage the conference call. In various example embodiments of the disclosure, the information that identifies the conference device 202 may comprise a MAC address, an IP address, a telephone number and/or other information that may be utilized to establish the conference call with the conference server 114. The information that identifies the location of a conference server 114 may comprise a MAC address, an IP address, a telephone number, a URL and/or other information that may be utilized to establish the conference call with the communication device 252.

The communication device 252 may utilize the information that identifies the conference server 114, for example, the URL, to communicate with the conference server 114 and request that a conference call be setup and/or that the conference device 252 be added to the conference call. For example, if the conference call has not previous been setup, then the communication device 252 may communicate with the conference server 114 to setup the conference call and be added as a participant to the conference call. If the conference was previously setup but has not started, then the communication device 252 may communicate with the conference server 114 and start the conference call and be added as a participant in the conference call. If the conference call was previously setup and is already in progress, then the communication device 252 may communicate with the conference server 114 in order to be added as a participant to the conference call.

The communication device 252 may also be operable to acquire information that may be stored on the communication device and/or information that may be stored on a remote device to setup and/or configure the conference call. The remote device may comprise another communication device and/or a server. In various example embodiments of the disclosure, the information acquired from the communication device 252 and/or the remote device may comprise information from a calendar, contacts, an email, a note, a message, a social destination and/or other similar type of source. Example messages may comprise an SMS or text message, and a multimedia message. Information that may be utilized to setup and/or configure the conference call may also be acquired from the one or more applications (apps) that may be running on the communication device 252.

In another embodiment of the disclosure, information that may be stored on the communication device 252 and/or information that may be stored on the remote device may be utilized to authenticate a user of the communication device 252 and/or the communication device 252. The authentication may be utilized to ensure that the user of the communication device 252 and/or the communication device 252 is authorized to participate in the conference call. In various example embodiments of the disclosure, information from the calendar, contacts, email, a note, one or more messages, social destination and/or other similar type of source may be utilized to authenticate the user of the communication device 252 and/or the communication device 252. The communication device 252 may be authenticated so that content and/or materials from the conference call may be shared with the communication device 252.

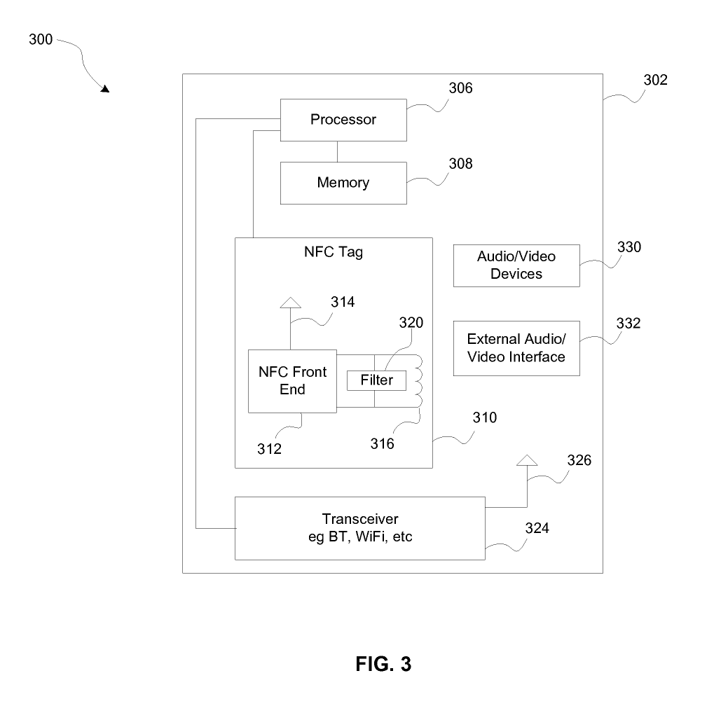

FIG. 3 is a block diagram illustrating an example conference device, which may be utilized for touch and talk auto-configuring of a video conference, in accordance with an embodiment of the disclosure. Referring to FIG. 3, there is shown a FIG. 300 comprising a conference device 302 with a NFC tag 310. The conference device 302 may comprise a processor 306, a memory 308, the NFC tag 310, a transceiver 324, an audio/video device 330 and an external audio/video device 332. The NFC tag 310 may comprise a NFC front end 312, an antenna 314, a coil 316 and a filter 320. The transceiver 324 may comprise an antenna 326.

The processor 306 may comprise suitable logic, circuitry, interfaces and/or code that may be operable to control one or more operations or functions of the conference device 302. The processor 306 may be substantially similar to the processor 206, which is described with respect to FIG. 2.

The memory 308 may comprise suitable logic, circuitry, interfaces and/or code that may be operable to store one or more settings, configuration, and/or operating code and/or data for the conference device 302. The memory 308 may be operable to store a corresponding NFC tag identifier (ID) for the NFC tag 310. The memory 308 may be substantially similar to the memory 208, which is described with respect to the FIG. 2.

The NFC front end 312 may comprise suitable logic, circuitry, interfaces and/or code that may be operable to handle analog NFC communication for the conference device 302.

The antenna 314 may comprise suitable logic, circuitry, interfaces that may be operable to handle the communication of signals for the NFC front end 312. The antenna 314 may be communicatively coupled to the NFC front end 312.

The coil 316 may comprise suitable logic, circuitry, and/or interfaces that may enable a current to be induced within the coil 316 whenever the NFC reader 262 in the communication device 252 is brought within operating proximity of the conference device 302. The coil 316 may be utilized to power up the NFC front-end 312 whenever the coil 316 is energized.

The filter 320 may comprise suitable circuitry, logic and/or code that may be operable to remove or filter out any undesired signals that may be generated by the NFC front-end 312. The filter 320 may be coupled to the NFC front-end 312 and the coil 316.

The transceiver 324 may comprise suitable logic, circuitry, interfaces and/or code that may be operable to enable the communication device 252 to communicate with one or more other devices such as the conference device 202. The transceiver 324 may be substantially similar to the transceiver 264 in the communication device 252. The antenna 326 may be communicatively coupled to the transceiver 324.

The antenna 326 may comprise suitable logic, circuitry, interfaces that may be operable to handle the communication of signals for the NFC front end 312. The antenna 326 may be communicatively coupled to the transceiver 324.

The audio/video device 330 may comprise suitable logic, circuitry, interfaces and/or code that may be operable to capture audio and/or video content for a conference call. The audio/video device 330 may be substantially similar to audio/video device 214 in the conference device 202. In various embodiments of the disclosure, the audio/video device 330 may comprise one or more microphones and/or one or more cameras, which may be utilized to capture the audio and/or video content for the conference call.

The external audio/video interface 332 may comprise suitable logic, circuitry, interfaces and/or code that may be operable to facilitate the coupling of one or more external audio/video devices to the conference device 302. For example, one or more microphones and/or one or more cameras may be communicatively coupled to the conference device 302 via the external audio/video interface 332. The external audio/video interface 332 may be substantially similar to external audio/video interface 216 in the conference device 202.

In operation, in one embodiment of the disclosure, the communication device 252 may be brought within proximity of the conference device 302. In this regard, when the NFC reader 262 in the communication device 252 is brought within NFC operating range of the NFC tag 310 in the conference device 302, the NFC tag 310 is energized and the NFC front end 312 is operable to communicate with the NFC reader 262. In this regard, the NFC reader 262 is operable to read, for example, information comprising an identifier of the conference device 252, the capability of the conference device 302 and a conference server 114 (FIG. 1) that may be operable to handle setup and/or configuration of conference calls for the conference device 302. The communication device 252 may utilize the read information to communicate with and setup and/or configure the conference call with the conference server 114. In instances where there may be a large group of participants in the room where conference device 302 is located and the audio/video device 330 may not be able to provide adequate audio and/or video coverage for all the participants, one or more microphones and/or cameras may be coupled to the conference device 302 via the external audio/video interface 332.

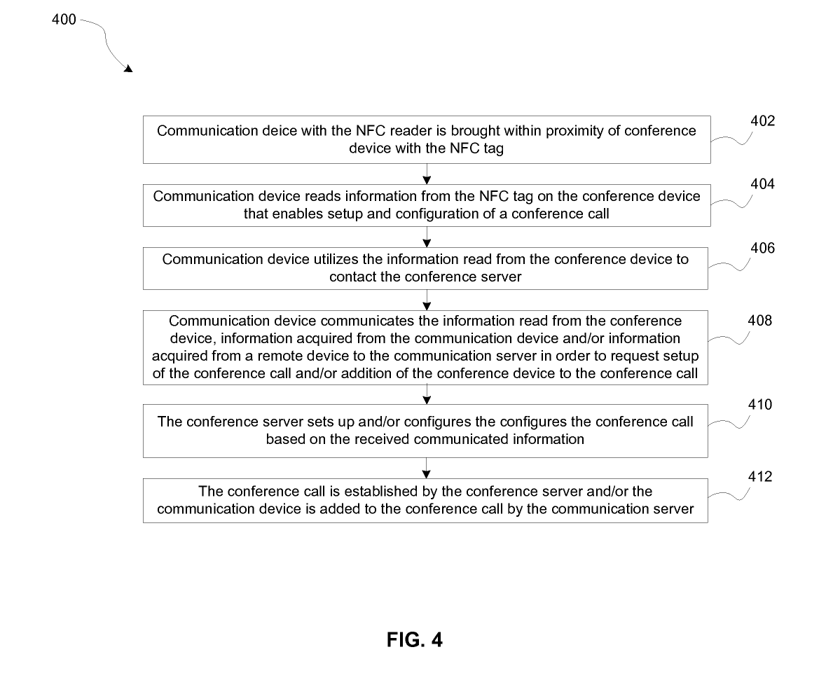

FIG. 4 is a flowchart illustrating example steps that may be utilized for providing touch and talk auto-configuring of a video conference using NFC, in accordance with an embodiment of the disclosure. Referring to FIG. 4, there is shown a flow chart 400 comprising example steps 402 through 412. The example steps start with step 402 in which the communication device 252 with the NFC reader 262 is brought within proximity of the conference device 202 with the NFC tag 210. In step 404, the communication device 252 reads information from the NFC tag 210 on the conference device 202 that enables setup and/or configuration of a conference call. In step 406, the communication device 252 utilizes the information that is read from the NFC tag 210 on the conference device 202 to contact the conference server 114.

In step 408, the communication device 252 communicates the information that is read from the conference device, information acquired from the communication device 252, and/or information acquired from a remote location to the conference server 114 in order to request setup of the conference call and/or addition of the conference device 202 to the conference call. In step 410, the conference server 114 sets up the conference call and/or configures the conference call based on the received communicated information. In step 412, the conference call is established by the conference server 114 and/or the conference device 202 is added to the conference call by the conference server 114.

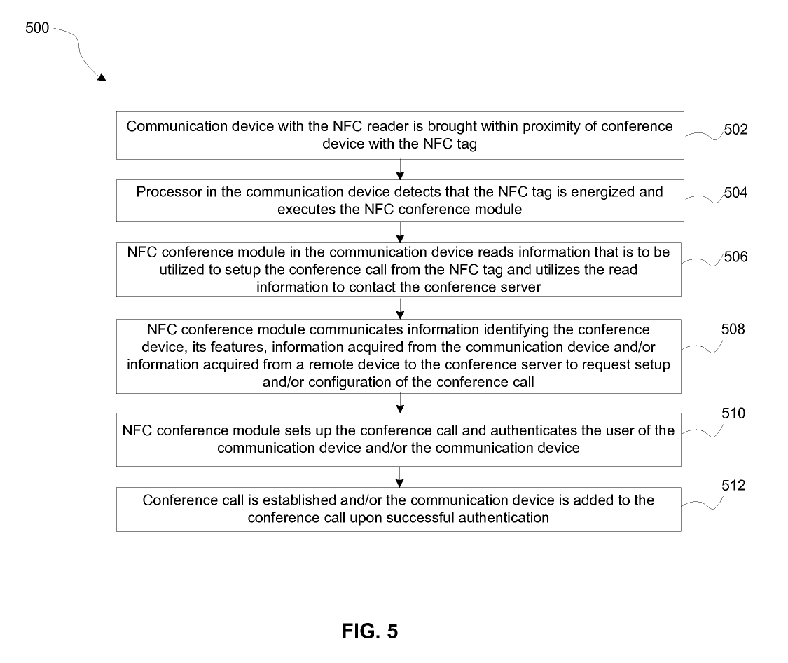

FIG. 5 is a flowchart illustrating example steps that may be utilized for providing touch and talk auto-configuring of a video conference using NFC, in accordance with an embodiment of the disclosure. Referring to FIG. 5, there is shown a flow chart 500 comprising example steps 502 through 512. The example steps start with step 502 in which the communication device 252 with the NFC reader 262 is brought within proximity of the conference device 202 with the NFC tag 210. In step 504, the processor 258 in the communication device 252 detects that the NFC tag 210 in the conference device 202 is energized and executes the NFC conference module 266. In step 506, the NFC conference module 266 in the communication device 252 reads the information that is to be utilized to setup the conference call from the NFC tag 210 and utilizes the read information to contact the conference server 114. In step 508, the NFC conference module 266 communicates information identifying the conference device 202, its features, information acquired from the communication device 252 and/or information acquired from a remote device to the conference server 114 to request setup and/or configuration of the conference call. In step 510, the NFC conference module 266 sets up the conference call and authenticates the user of the communication device 252 and/or the communication device 252. In step 512, the conference call is established and/or the communication device 252 is added to the conference call upon successful authentication.

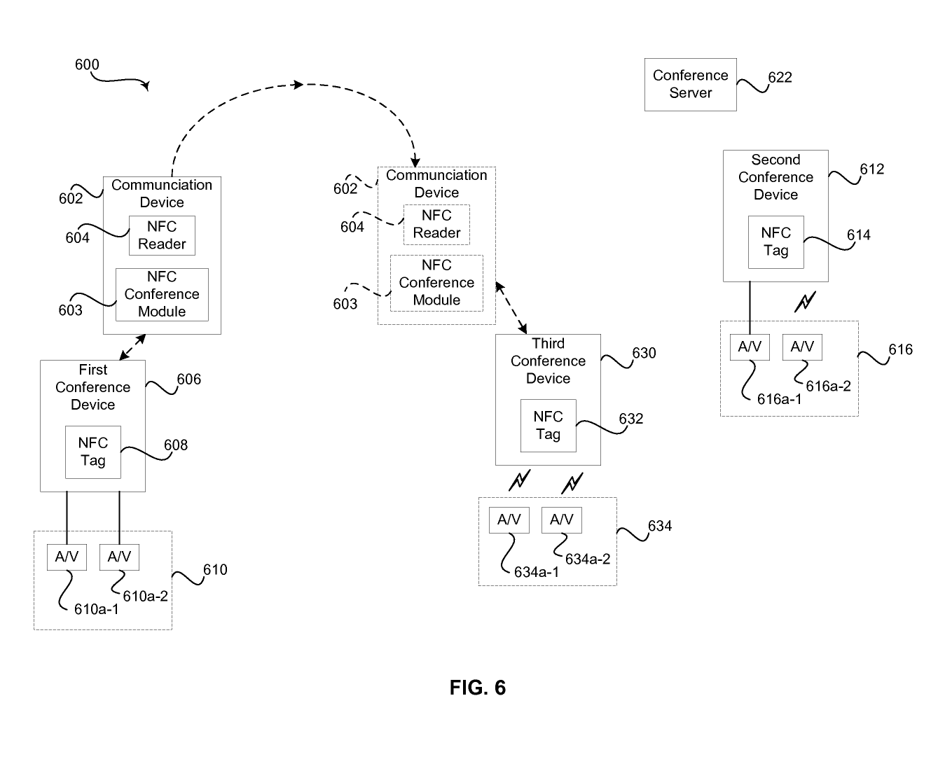

FIG. 6 is a diagram that illustrates an example system for providing touch and talk auto-configuring of a video conference using NFC, in accordance with an embodiment of the disclosure. Referring to FIG. 6, there is shown an example communication device 602, a first conference device 606, a second conference device 612, a third conference device 630. FIG. 6 also shows audio/video devices 610, 616 and 634, which are coupled to the first conference device 606, the second conference device 612 and the third conference device 630, respectively.

The communication device 602 may be substantially similar to the communication device 102a, which is described with respect to FIG. 1. The communication device 602 may comprise an NFC reader 604 and a NFC conference module 603. The NFC reader 604 may be substantially similar to the NFC reader 262, which may be described with respect to FIG. 2. The NFC conference module 603 may be substantially similar to the NFC conference module 266, which may be described with respect to FIG. 2.

The first conference device 606, the second conference device 612, the third conference device 630 each comprise an NFC tag 608, 614 and 632, respectively. Each of the NFC tags 608, 614 and 632 are substantially similar to the NFC tag 210, which may be described with respect to FIG. 2.

A plurality of audio/video devices 610 are shown coupled to the first conference device 606. In this regard, wired audio/video devices 610a-1, 610a-2 are coupled to the first conference device 606. A plurality of audio/video devices 616 are shown coupled to the second conference device 612. In this regard, a wired audio/video device 616a-1 and a wireless audio/video device 616a-2 are shown coupled to the second conference device 612. A plurality of audio/video devices 634 are shown coupled to the third conference device 630. In this regard, wireless audio/video devices 634a-1, 634a-2 are shown coupled to the third conference device 630. The wireless audio/video devices 616a-2, 634a-1, 634a-2 are substantially similar to the wireless audio/video devices 106b-2, 106c-1, 106c-2, which are shown and described with respect to FIG. 1.

With reference to FIG. 6, certain embodiments of the disclosure for touch and talk auto-configuring video conferences using NFC may comprise a communication device 602, which comprises an NFC reader 604. The NFC reader 604 is operable to read a first NFC tag 608 on a first conference device 606 when the communication device 602 comprising the NFC reader 604 is brought within operating proximity of the first NFC tag 608 on the first conference device 606. Information read from the first NFC tag 608 and information acquired by the communication device 602 may be communicated to a conference server 622. The conference server 622 is operable to utilize the communicated information read from the first NFC tag 608 and the communicated information acquired by the communication device 602 to configure a conference call between the first conference device 606 and at least a second conference device 612. The conference call may comprise a voice conferencing call and/or video conferencing call. The communication device 602, the first conference device 606 and at least the second conference device 612 are separate and distinct devices.

The communication device 602 may be operable to execute a module 603, which may be referred to as an NFC conference module, which is operable to handle the communication of the information read from the first NFC tag 608 and the information acquired by the communication device 602 to the conference server 622. The NFC conference module 603 on the communication device 602 may be executed or launched whenever the communication device 602 is brought within the operating proximity of the first NFC tag 608 on the first conference device 606. The module 603 may comprise an application that runs on an operating system platform of the communication device 602 or the module 603 may be integrated as part of an operating system platform of the communication device 602.

The information read from the first NFC tag 608 may comprise data that uniquely identifies the first conference device 606. The communication device 602 may utilize the information read from the first NFC tag 608 to communicate with the conference server 622. The information acquired by the communication device 602 and communicated to the conference server 622 may comprise information that authenticates a user of the communication device 602 that is a participant of the conference call or the conference device 602 that is authorized to take part in the conference call. The information acquired by the communication device 602 and communicated to the conference server 622 may comprise information acquired from one or more of a calendar, a contact, a message, an email, a note, and a social destination. The information acquired by the communication device 602 and communicated to the conference server 622 may comprise local information, which may be stored on the communication device 602 and/or remote information from another entity or device.

The communication device 602 may be operable to initiate transfer of the conference call and/or resumption of the conference call from the first conference device 606 to a third conference device 630 comprising a third NFC tag 632 when the communication device 602 comprising the NFC reader 604 is brought within proximity of the third NFC tag 632 on the third conference device 630.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for touch and talk auto-configuring video conferences using NFC

Accordingly, the present disclosure may be realized in hardware, software, or a combination of hardware and software. The present disclosure may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method, comprising:
on a communication device comprising an NFC reader:
reading by said NFC reader, a first NFC tag on a first conference device when said communication device comprising said NFC reader is brought within proximity of said first NFC tag on said first conference device; and
communicating information read from said first NFC tag and information acquired by said communication device to a conference server, wherein:
said conference server utilizes said communicated information read from said first NFC tag and said communicated information acquired by said communication device to configure a conference call between said first conference device and at least a second conference device; and
said communication device, said first conference device and at least said second conference device are separate and distinct devices.

2. The method according to claim 1, comprising executing, on said communication device, a module that handles said communication of said information read from said first NFC tag and said information acquired by said communication device to said conference server.

3. The method according to claim 2, comprising initiating said execution of said module on said communication device when said communication device is brought within said proximity of said first NFC tag on said first conference device.

4. The method according to claim 2, wherein said executed module comprises an application that runs on an operating system platform of said communication device.

5. The method according to claim 1, wherein said executed module is integrated as part of an operating system platform of said communication device.

6. The method according to claim 1, wherein said information read from said first NFC tag comprises data that uniquely identifies said first conference device.

7. The method according to claim 1, comprising communicating with said conference server utilizing said information read from said first NFC tag.

8. The method according to claim 1, wherein said information acquired by said communication device and communicated to said conference server comprises information that authenticates a user of said communication device that is a participant of said conference call.

9. The method according to claim 1, wherein said information acquired by said communication device and communicated to said conference server comprises information acquired from one or more of a calendar, a contact, a message, an email, a note, and a social destination.

10. The method according to claim 1, wherein said information acquired by said communication device and communicated to said conference server comprises local information on said communication device and/or remote information from another entity.

11. The method according to claim 1, comprising initiating transfer and/or resumption of said conference call from said first conference device to a third conference device comprising a third NFC tag when said communication device comprising said NFC reader is brought within proximity of said third NFC tag on said third conference device.

12. The method according to claim 1, wherein said conference call comprises one or both of voice conferencing and/or video conferencing.

13. A system, comprising:
a communication device comprising an NFC reader, said communication device being operable to:
read by said NFC reader, a first NFC tag on a first conference device when said communication device comprising said NFC reader is brought within proximity of said first NFC tag on said first conference device; and
communicate information read from said first NFC tag and information acquired by said communication device to a conference server, wherein:
said conference server utilizes said communicated information read from said first NFC tag and said communicated information acquired by said communication device to configure a conference call between said first conference device and at least a second conference device; and
said communication device, said first conference device and at least said second conference device are separate and distinct devices.

14. The system according to claim 13, wherein said communication device is operable to execute, on said communication device, a module that handles said communication of said information read from said first NFC tag and said information acquired by said communication device to said conference server.

15. The system according to claim 14, wherein said communication device is operable to initiate said execution of said module on said communication device when said communication device is brought within said proximity of said first NFC tag on said first conference device.

16. The system according to claim 14, wherein said executed module comprises an application that runs on an operating system platform of said communication device.

17. The system according to claim 13, wherein said executed module is integrated as part of an operating system platform of said communication device.

18. The system according to claim 13, wherein said information read from said first NFC tag comprises data that uniquely identifies said first conference device.

19. The system according to claim 13, wherein said communication device is operable to communicate with said conference server utilizing said information read from said first NFC tag.

20. The system according to claim 13, wherein said information acquired by said communication device and communicated to said conference server comprises information that authenticates a user of said communication device that is a participant of said conference call.

21. The system according to claim 13, wherein said information acquired by said communication device and communicated to said conference server comprises information acquired from one or more of a calendar, a contact, a message, an email, a note, and a social destination.

22. The system according to claim 13, wherein said information acquired by said communication device and communicated to said conference server comprises local information on said communication device and/or remote information from another entity.

23. The system according to claim 13, wherein said communication device is operable to initiate transfer and/or resumption of said conference call from said first conference device to a third conference device comprising a third NFC tag when said communication device comprising said NFC reader is brought within proximity of said third NFC tag on said third conference device.

24. The system according to claim 13, wherein said conference call comprises one or both of voice conferencing and/or video conferencing.

25. A system, comprising:
a communication device comprising an NFC reader, a first conference device comprising a first NFC tag and a conference server, wherein:
said NFC reader reads information from said first NFC tag when said communication device is brought within NFC operating range of said first NFC tag;
said communication device communicates said read information and information acquired by said communication device to said conference server; and
said conference server configures a conference call between said first conference device and at least a second conference device based on said communicated information read from said first NFC tag and said communicated information acquired by said communication device.
